(19) United States
(12) Patent Application Publication
(10) Pub. No.: US 2025/0326247 A1
(43) Pub. Date: Oct. 23, 2025

(54) Filigree glue dripping enamel painting process

(71) Applicant: Ming Xu, Xi’an (CN)

(72) Inventor: Ming Xu, Xi’an (CN)

(21) Appl. No.: 18/643,985

(22) Filed: Apr. 23, 2024

(51) Int. Cl. B44C 3/04; B44F 3/00

(52) U.S. Cl. CPC B44C 1/00

(57) ABSTRACT

The invention is directed to the field of crafts production technology, in particular to filigree glue dripping enamel painting process. The following steps are included: Step 1: to choose a pattern and create it; Step 2: Filigree; Step 3: fixing; Step 4: coloring and glue dripping; Step 5: making decoration; Step 6: upper sealing; step 7: PET tape removing; Step 8: Reprocessing, bottom sealing and decoration; Step 9: attachments mounting. The production process of this filigree glue dripping enamel painting involves combining the filigree enamel process with the glue process to optimize the advantages of both techniques. It can modify both the shape and color, and can better adjust the transition color in detail, resulting in a more uniform solid color. Filigree glue dripping enamel painting process allows to create clear lines and rich gradient colors with simple glue.

### FIELD OF THE INVENTION

The present application relates to the field of crafts production technology, in particular to filigree glue dripping enamel painting process.

### BACKGROUND

As people's living standards and material wealth continue to improve, their demand for high-quality decorative arts has grown. They now seek pieces that are not only aesthetically pleasing but also environmentally friendly and healthy. Traditional Chinese handicrafts are becoming increasingly popular due to their deep cultural heritage, beauty, and craftsmanship. They are also known for their health benefits. Filigree enamel painting crafts are a type of traditional art that utilizes exquisite decorative techniques to create charming metal and green colors. They possess a unique national style and radiate a gorgeous artistic rhythm. They are highly appreciated by art enthusiasts and reflect the owner's artistic appreciation ability.

The traditional process of producing filigree enamel painting crafts involves using flat copper wire to create lines and welding them onto a copper bottle. Once the desired shape is achieved, the pattern is filled with enamel color. The piece is then fired at high temperatures, ground, and finally plated with metal. However, certain metals, such as tin, have a lower melting point of 231.89 degrees Celsius. Since the temperature for firing enamel is usually between 800 to 1000 degrees Celsius, using tin as filigree for enamel firing can cause the filigree to melt and deform, while the enamel burns at the same time. As a result, the melted enamel will cover the surface of the metal wire, making the metal filigree appear incomplete and the finished product less attractive.

With the advancements in traditional craftsmanship, modern simplified filigree enamel production processes have been developed. In this process, metal wires are fixed onto utensils via metal wire glue. Colored sand is then filled in and fixed with sand-fixing glue. Finally, a film of glue is coated to fix the color and sand. However, this fixation process has some shortcomings such as uneven fixation, discoloration, and complicated procedures.

Another method of resin glue involves mixing color essence with either UV glue or AB glue to adjust the color. The mixed glue is then poured into a mold with a fixed shape, making it difficult to create a personalized shape and adjust the target color. Moreover, when placed in a fixed position, it becomes challenging to adjust the transition color in detail. Additionally, there is a risk of discoloration of the color essence, leading to a considerable gap between the finished product and the design draft.

Therefore, given this situation, the traditional process was improved and a filigree glue dripping enamel painting process was designed.

### SUMMARY

The present invention aims to solve a technical problem by addressing the shortcomings of the existing technology. Specifically, it provides a method for creating filigree resin enamel, which includes fixing the metal wires, gluing the wire, coloring, resin glue, beautifying and decorating the enamel, and adding a sealing layer.

In order to solve technical problems, the present invention introduces a filigree glue dripping enamel painting process with these steps:

Step 1: To choose a pattern and create it;

S1. When selecting a pattern, it could either draw a picture based on the preferences or choose a suitable image based on the situation;

S2. When creating a pattern:

a. In the case of attachments, draw the required pattern directly on the attachment;

To create a pattern using a picture, follow these steps: place the carbon paper over the attachment, place the desired picture on top of the copy paper, then trace the pattern onto the attachment using a pen; this will transfer the pattern onto the attachment accurately;

b. When there is no attachment, the process is as follows: first, draw the required pattern on a piece of paper; then, cover the pattern with PET tape, making sure that the adhesive side is facing up; next, use transparent tape to fix the PET tape and the drawing on the patterned paper; finally, make sure that the pattern and PET tape are flat and secure.

When using a picture as a pattern, cover it with PET tape adhesive side up and fix it in place with transparent tape. Then, flatten the pattern and PET tape.

Step 2: filigree:

a. To trace a pattern, use B-7000 glue and apply it evenly to the edges of the pattern outline; then, use a wire-rolling board to clamp the metal wire and flatten it; while the glue is still wet, use tweezers or needle-nose pliers to shape the metal wire according to the pattern; fold out the shape corresponding to the outline of the pattern, and use scissors to cut the metal wires vertically at the connection points; the metal wire can then be directly glued to the pattern;

b. Place the screw 1 in the correct position on the folded wire pattern.

Step 3: Fixing

a. Once the filigree is finished, lightly tap the pinched metal wire with a rubber mallet to flatten it.

b. Once the metal wire outline is created, use a brush to apply a small amount of UV glue between the metal wire and the bottom PET tape; then, cure the UV lamp to shape the metal wire outline; simultaneously, use a brush to apply the metal wire outline evenly and thinly on the blank space; apply a layer of UV glue on top and then cure it with a UV lamp; then the bottom layer finished.

Step 4: coloring and glue dripping:

Mix the colored sand or powder that you want to fill into powder 1 or powder 2, and then pour it onto the palette; add a small amount of UV glue, and mix thoroughly via a small spatula;

when using colored toner or colored sand to create a glossy effect, the ideal ratio of powder to glue is 1:2; fill the outline of the delicate metal wire with the toner mixture and use a small spatula to adjust any excess color to ensure an even look; afterwards, use a lighter to heat the surface of the UV glue to remove any bubbles that may have formed;

when working with colored sand, it is important to maintain the texture of the sand, resulting in a matte surface; to achieve this, the sand-to-glue ratio should be around 3:1; begin by pouring colored sand onto a palette and add glue in a small amount of times until the colored sand sticks without overflowing; it is important to add glue slowly to avoid any overflow; fill the artwork with the sand glue mixture and smooth it out to prevent the metal wire from overflowing; keep in mind that due to the unique characteristics of sand, additional drying and lighting time may be necessary.

Step 5: making decoration:

Place diamonds, mica, and abalone shells in wire outline, and cure with UV lamp for 2-5 minutes until the UV glue solidifies.

Step 6: upper sealing:

To apply another layer of glue via a brush and remove any bubbles on the surface with a lighter; then, cure the craft for 5-10 minutes and let it stand for 1-2 hours until the surface is completely dry; make sure the interior is cooled, smooth and non-sticky before completing the front.

a. If there are any attachments, the delicate glue crafts are now finished.

b. If there is no attachment, continue to the next step.

Step 7: PET tape removing:

To finish the craft, start by tearing off the transparent tape from the drawing; then remove the handicraft carefully; cure with the UV light on the back of the craft, which is covered by the PET tape; this will help to cure the UV glue; finally, remove the green PET tape.

Step 8: Reprocessing, bottom sealing and decoration:

To create a glittering effect, it is required to follow these steps; first, use powder 3 to smear the bottom surface of the craft; next, apply a layer of UV glue on the back and carefully check for any bubbles; then, use a lighter to cure it, and seal it with a light;

Remove the excess glue around the wireframe with a nail file or scissors, taking care not to cut the wire;

To complete the craft, adorn the bottom and follow the instructions provided in steps six and seven once again;

This step may be skipped if not required;

Step 9: Attachments mounting:

To finish the production of filigree enamel crafts, it is necessary to install the appropriate accessories.

Wherein the attachments can be various items such as wooden boards, porcelain plates, mobile phone cases, refrigerator magnets, acrylic sheets, jewelry boxes, etc.

Wherein in the second step, insert and secure the screw 1, and reserve a spot beforehand to make it easier to add necklaces, earrings, and keychains later on.

Wherein characteristics of powder 1: bright, texture with glittering particles.

Wherein characteristics of powder 2: luminous, glowing at night under sufficient light during the day.

Wherein characteristics of powder 3: polarizing effect.

Wherein for the installation accessories of jewelry, necklaces, earring hooks, and ear studs could be used; additionally, applying UV glue to brooch buckles, ring holders, and duckbill clips; when applying UV glue to brooch buckles, it is important to dry them by shining a light on them; this will complete the production process for the filigree UV jewelry.

Wherein when making an artwork, various types of glue such as UV glue, AB glue, crystal hard glue, transparent or opaque quick-drying glue, or sand-fixing glue could be selected depending on the situation.

Wherein, during processing, mica flakes, shell flakes, sequins, glitter powder, manicure diamonds, dried flowers, plastic decorations, or photos could be added.

Wherein the mixed glue can be colored with a variety of substances, such as colored sand, color powder, glitter powder, luminous powder and color essence.

The present invention has an advantage over the prior art. It combines the production methods of the filigree enamel process and the glue process to create filigree enamel crafts. The fusion of these two methods results in various shapes, richer gradient colors, better color transitions in the details, and more uniform solid colors. The filigree enamel process, in combination with simple glue, produces clear lines and rich gradient colors. These crafts can be applied to objects like mobile phone cases, refrigerator magnets, bookmarks, and coasters. They can also be made into separate pieces such as earrings, pendants, hairpins, brooches, and rings. The crafts can be made into both flat and three-dimensional shapes to provide more options for personalized jewelry.

Additionally, this process is user-friendly, with simple steps that facilitate widespread use.

This process avoids filigree melting and deformation when using tin as filigree for enamel firing, resulting in a more perfect display of handicrafts without firing.

### BRIEF DESCRIPTION OF THE DRAWINGS

FIG. 1 is a flow chart of a filigree glue dripping enamel painting process, according to an embodiment.

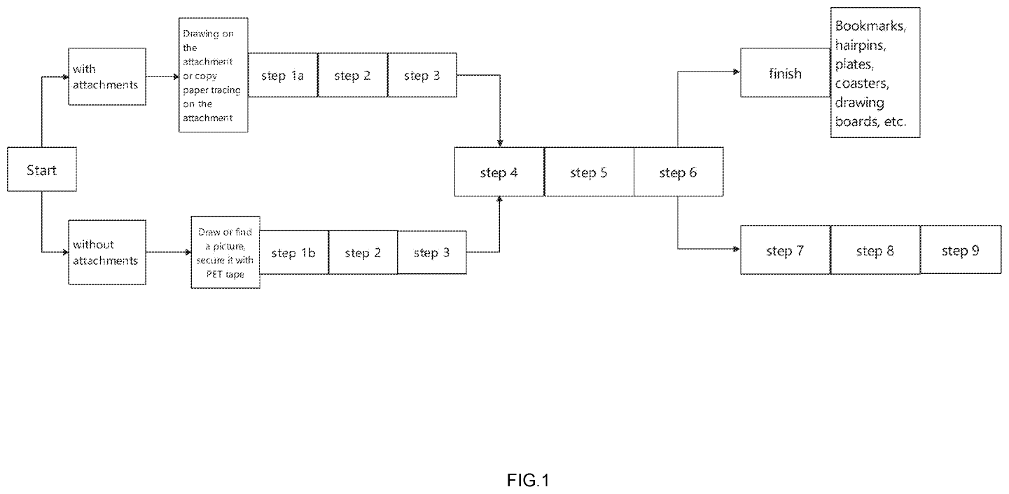

### DETAILED DESCRIPTION OF EMBODIMENTS

The embodiments of the present technology described herein are not intended to be exhaustive or to limit the technology to the precise forms disclosed in the following detailed description. Rather, the embodiments are chosen and described so that others skilled in the art can appreciate and understand the principles and practices of the present technology.

All publications and patents mentioned herein are hereby incorporated by reference. The publications and patents disclosed herein are provided solely for their disclosure. Nothing herein is to be construed as an admission that the inventors are not entitled to antedate any publication and/or patent, including any publication and/or patent cited herein.

A filigree glue dripping enamel painting process, comprising with following steps:

Step 1: to choose a pattern and create it;

S1. When selecting a pattern, it could either draw a picture based on the preferences or choose a suitable image based on the situation;

S2. When creating a pattern:

a. In the case of attachments, draw the required pattern directly on the attachment;

To create a pattern using a picture, follow these steps: place the carbon paper over the attachment, place the desired picture on top of the copy paper, then trace the pattern onto the attachment using a pen; this will transfer the pattern onto the attachment accurately;

The attachments can be various items such as wooden boards, porcelain plates, mobile phone cases, refrigerator magnets, acrylic sheets, jewelry boxes, etc.

When there is no attachment, the process is as follows: first, draw the required pattern on a piece of paper; then, cover the pattern with PET tape, making sure that the adhesive side is facing up; next, use transparent tape to fix the PET tape and the drawing on the patterned paper; finally, make sure that the pattern and PET tape are flat and secure;

When using a picture as a pattern, cover it with PET tape adhesive side up and fix it in place with transparent tape. Then, flatten the pattern and PET tape.

Step 2: Filigree:

a. To trace a pattern, use B-7000 glue and apply it evenly to the edges of the pattern outline; then, use a wire-rolling board to clamp the metal wire and flatten it; while the glue is still wet, use tweezers or needle-nose pliers to shape the metal wire according to the pattern; fold out the shape corresponding to the outline of the pattern, and use scissors in the direction of vertical wires to remove any excess wire; the metal wire can then be directly glued to the pattern;

b. place the screw 1 in the correct position on the folded wire pattern;

Step 3: Fixing:

a. once the filigree is finished, lightly tap the pinched metal wire with a rubber mallet to flatten it;

b. once the metal wire outline is created, use a brush to apply a small amount of UV glue between the metal wire and the bottom PET tape; then, cure the UV lamp to shape the metal wire outline; simultaneously, use a brush to apply the metal wire outline evenly and thinly on the blank space; apply a layer of UV glue on top and then cure it with a UV lamp; then the bottom layer finished.

Step 4: Coloring and glue dripping:

mix the colored sand or powder that you want to fill into powder 1 or powder 2, and then pour it onto the palette; add a small amount of UV glue, and mix thoroughly via a small spatula;

When using colored toner or colored sand to create a glossy effect, the ideal ratio of powder to glue is 1:2; fill the outline of the delicate metal wire with the toner mixture and use a small spatula to adjust any excess color to ensure an even look; afterwards, use a lighter to heat the surface of the UV glue to remove any bubbles that may have formed;

when working with colored sand, it is important to maintain the texture of the sand, resulting in a matte surface; to achieve this, the sand-to-glue ratio should be around 3:1; begin by pouring colored sand onto a palette and add glue in a small amount of times until the colored sand sticks without overflowing; it is important to add glue slowly to avoid any overflow; fill the artwork with the sand glue mixture and smooth it out to prevent the metal wire from overflowing; keep in mind that due to the unique characteristics of sand, additional drying and lighting time may be necessary.

Wherein characteristics of powder 1: bright, texture with glittering particles.

Wherein characteristics of powder 2: luminous, glowing at night under sufficient light during the day.

Step 5: Making decoration:

Place diamonds, mica, and abalone shells in wire outline, and cure with UV lamp for 2-5 minutes until the UV glue solidifies.

Step 6: Upper sealing:

To apply another layer of glue via a brush and remove any bubbles on the surface with a lighter; then, cure the work for 5-10 minutes and let it stand for 1-2 hours until the surface is completely dry; make sure the interior is cooled, smooth and non-sticky before completing the front.

a. if there are any attachments, the delicate glue crafts are now finished.

b. if there is no attachment, continue to the next step.

Step 7: PET tape removing:

To finish the craft, start by tearing off the transparent tape from the drawing; then remove the handicraft carefully; cure with the UV light on the back of the craft, which is covered by the PET tape; this will help to bake the UV glue; finally, remove the green PET tape.

Step 8: reprocessing, bottom sealing and decoration:

To create a glittering effect, it is required to follow these steps; first, use powder 3 to smear the bottom surface of the craft; next, apply a layer of UV glue on the back and carefully check for any bubbles; then, use a lighter to cure it, and seal it with a light;

Remove the excess glue around the wireframe with a nail file or scissors, taking care not to cut the wire;

To complete the craft, adorn the bottom and follow the instructions provided in steps six and seven once again;

This step may be skipped if not required;

Wherein characteristics of powder 3: polarizing effect.

Step 9: Attachments mounting:

To finish the production of filigree enamel crafts, it is necessary to install the appropriate accessories.

In the specific implementation of the present invention, the filigree glue dripping enamel painting process has the following specific steps:

Step 1: to choose a pattern and create it;

S1. When selecting a pattern, it could either to draw one that suits one's taste or choose one from a variety of options available at handicraft stores. Some stores even allow customers to create their patterns. If drawing isn't one's strong suit or if someone have a specific pattern in mind, who can also choose from pre-made options such as those found in manuals or children's activity books. Regardless of one's preference, there are numerous excellent options to select from.

S2. When creating a pattern:

a. In the case of attachments, the attachments can be various items such as wooden boards, porcelain plates, mobile phone cases, refrigerator magnets, acrylic sheets, jewelry boxes, etc.

In this case, the pattern must be hand-drawn directly on the attachment when creating a picture as a pattern.

When using a picture as a pattern for painting, start by laying the carbon paper flat on the attachment. Then, place the selected picture flat on the carbon paper. Fix both the picture and carbon paper to prevent any movement during the painting process. Next, use a pen to trace the pattern onto the attachment. It is important to apply a certain amount of force while painting to ensure that the pattern is printed clearly and accurately.

Additionally, an object with a small, round head could be used to trace the pattern onto the attachment.

b. When there is no attachment, the process is as follows: first, draw the required pattern on a piece of paper; then, cover the pattern with PET tape, making sure that the adhesive side is facing up; next, use transparent tape to fix the PET tape and the drawing on the patterned paper; finally, make sure that the pattern and PET tape are flat and secure. To prevent glue from dripping unevenly and causing distortion.

When using a picture as a pattern, cover it with PET tape adhesive side up and fix it in place with transparent tape. Then, flatten the pattern and PET tape. To prevent glue from dripping unevenly and causing distortion.

Step 2: Filigree:

a. To trace a pattern, use B-7000 glue and apply it evenly to the edges of the pattern outline; then, use a wire-rolling board to clamp the metal wire and flatten it; while the glue is still wet, use tweezers or needle-nose pliers to shape the metal wire according to the pattern; fold out the shape corresponding to the outline of the pattern. It is important not to overlook small details. Use available tools to achieve desired shape. For example, a screwdriver can be used to create a circle. Use scissors to remove any excess wire; the metal wire can then be directly glued to the pattern;

To ensure a neat appearance of a craft, it is important to remove any excess glue that might have squeezed out from the metal wire. Once the glue has fully dried, a knife could be used to carefully trim off any protruding glue from the edges. Any glue left on the wire could affect the overall appearance of the craft.

b. place the screw 1 in the correct position on the folded wire pattern. To make it easier to add necklaces, earrings, keychains, and other items later on, please reserve a spot in advance.

Step 3: Fixing

a. Once the filigree is finished, lightly tap the pinched metal wire with a rubber mallet to flatten it;

b. Once the metal wire outline is created, use a brush to apply a small amount of UV glue between the metal wire and the bottom PET tape; then, cure the UV lamp to shape the metal wire outline; simultaneously, use a brush to apply the metal wire outline evenly and thinly on the blank space; apply a layer of UV glue on top and then cure it with a UV lamp; then the bottom layer finished.

Step 4: Coloring and glue dripping:

Mix the colored sand or powder that you want to fill into powder 1 or powder 2, and then pour it onto the palette; add a small amount of UV glue, and mix thoroughly via a small spatula;

When using colored toner or colored sand to create a glossy effect, the ideal ratio of powder to glue is 1:2; fill the outline of the delicate metal wire with the toner mixture and use a small spatula to adjust any excess color to ensure an even look; afterwards, use a lighter to heat the surface of the UV glue to remove any bubbles that may have formed;

The glue used for sticking can be UV glue, AB glue, or other types of crystal, hard, transparent, or quick-drying glue. Sand-fixing glue could also be used. The sealing glue is not limited to UV glue, AB glue, nail polish glue, or sand-fixing glue.

Wherein characteristics of powder 1: bright, texture with glittering particles. Various colors of powder 1 can enhance the brightness and texture of handicrafts.

Wherein characteristics of powder 2: luminous, glowing at night under sufficient light during the day. By adding powder 2 to handicrafts, which could give them luminous properties and make them more beautiful. There are multiple colors available to choose from, allowing for diverse color options. Depending on the production situation and personal preference, powder 1 and powder 2 can be added accordingly.

when working with colored sand, it is important to maintain the texture of the sand, resulting in a matte surface; to achieve this, the sand-to-glue ratio should be around 3:1; begin by pouring colored sand onto a palette and add glue in a small amount of times until the colored sand sticks without overflowing; it is important to add glue slowly to avoid any overflow; fill the artwork with the sand glue mixture and smooth it out to prevent the metal wire from overflowing; keep in mind that due to the unique characteristics of sand, additional drying and lighting time may be necessary.

The mixed glue can be colored with various materials including sand, powder, glitter, luminous powder, and color essence.

Step 5: Making decoration:

Place diamonds, mica, and shells in wire outline, and cure with UV lamp for 2-5 minutes until the UV glue solidifies.

During the process, accessories such as sequins, glitter powder, manicure diamonds, dried flowers, plastic decorations, photos, polarizing powder and diamonds could be selected.

Step 6: Upper sealing:

To apply another layer of glue via a brush and remove any bubbles on the surface with a lighter; then, cure the work for 5-10 minutes and let it stand for 1-2 hours until the surface is completely dry; make sure the interior is cooled, smooth and non-sticky before completing the front.

a. If there are any attachments, the delicate glue crafts are now finished.

b. If there is no attachment, continue to the next step.

Step 7: PET tape removing:

To finish the craft, start by tearing off the transparent tape from the drawing; then remove the handicraft carefully; cure with the UV light on the back of the craft, which is covered by the PET tape; this will help to cure the UV glue; finally, remove the green PET tape.

Step 8: reprocessing, bottom sealing and decoration:

To create a glittering effect, it is required to follow these steps; first, use powder 3 to smear the bottom surface of the craft; next, apply a layer of UV glue on the back and carefully check for any bubbles; then, use a lighter to cure it, and seal it with a light;

Remove the excess glue around the wireframe with a nail file or scissors, taking care not to cut the wire;

To complete the craft, adorn the bottom and follow the instructions provided in steps six and seven once again;

This step may be skipped if not required;

Characteristics of powder 3: polarizing effect.

Step 9: Attachments mounting:

To complete filigree enamel crafts, it can install various accessories such as necklaces, earring hooks, ear studs, brooch buckles, ring holders, and duckbill clips. UV glue could be used to coat these accessories and when applying it to brooch buckles, it is required to dry them by exposing them to light. Once all the accessories are installed, the production of filigree enamel crafts is complete.

Part of the product list:

Tools: instructions, wire, scissors, tweezers, spatula, brush, bamboo skewer, tape, wooden board.

Color mixing tools: UV lamp, UV glue, palette, 12 colors, powder 1, powder 2.

Decorative tools: mica flakes, abalone shells, decorative diamonds.

Assembly: Duckbill clip, brooch holder, key chain, earring hook, ring holder, split ring, claw nails.

Partial tool description:

Wooden board: Clamp the metal wire with a wooden board and arrange the wire flatly

Metal wire: When filigreeing, use the side of the metal wire to fold out the desired outline and details in the outline.

Scissors: Cut the metal wire perpendicularly to the connection point of the metal wire.

Tweezer: Use tweezers to clamp the wire where it needs to be bent, and pull it in the direction of the line in the picture.

Bamboo skewer: Dip a bamboo skewer into the UV glue and wrap it around the metal wire. Remove excess glue as needed.

Tapes: For temporary fixing of metal wire. Cut a piece of tape and attach it to the pattern, with the adhesive side on top, and fix both ends flat with tape. The uneven tape will cause the glue to deform.

Powder 1: With pearlescent glitter effect, add with small amount.

Powder 2: With luminous effect, add with small amount.

Powder 3: With polarizing effect, add with small amount.

While the technology is susceptible to various modifications and alternative forms, specifics thereof have been shown by way of example and drawings, and will be described in detail. It should be understood, however, that the application is not limited to the particular embodiments described. On the contrary, the application is to cover modifications, equivalents, and alternatives falling within the spirit and scope of the technology.

1. A filigree glue dripping enamel painting process, comprising with following steps:
step 1: to choose a pattern and create it;
S1. when selecting a pattern, it could either draw a picture based on the preferences or choose a suitable image based on the situation;
S2. when creating a pattern:
a. in the case of attachments, draw the required pattern directly on the attachment;
to create a pattern using a picture, follow these steps: place the carbon paper over the attachment, place the desired picture on top of the copy paper, then trace the pattern onto the attachment using a pen; this will transfer the pattern onto the attachment accurately;
b. when there is no attachment, the process is as follows: first, draw the required pattern on a piece of paper; then, cover the pattern with PET tape, making sure that the adhesive side is facing up; next, use transparent tape to fix the PET tape and the drawing on the patterned paper; finally, make sure that the pattern and PET tape are flat and secure;
when using a picture as a pattern, cover it with PET tape adhesive side up and fix it in place with transparent tape. Then, flatten the pattern and PET tape;
step 2: filigree:
a. to trace a pattern, use B-7000 glue and apply it evenly to the edges of the pattern outline; then, use a wire-rolling board to clamp the metal wire and flatten it; while the glue is still wet, use tweezers or needle-nose pliers to shape the metal wire according to the pattern; fold out the shape corresponding to the outline of the pattern, and use scissors to cut the metal wires vertically at the connection points; the metal wire can then be directly glued to the pattern;
b. place the screw 1 in the correct position on the folded wire pattern;
step 3: fixing
a. once the filigree is finished, lightly tap the pinched metal wire with a rubber mallet to flatten it;
b. once the metal wire outline is created, use a brush to apply a small amount of UV glue between the metal wire and the bottom PET tape; then, cure the UV lamp to shape the metal wire outline; simultaneously, use a brush to apply the metal wire outline evenly and thinly on the blank space; apply a layer of UV glue on top and then cure it with a UV lamp; then the bottom layer finished;
step 4: coloring and glue dripping:
mix the colored sand or powder that you want to fill into powder 1 or powder 2, and then pour it onto the palette; add a small amount of UV glue, and mix thoroughly via a small spatula;
when using colored toner or colored sand to create a glossy effect, the ideal ratio of powder to glue is 1:2; fill the outline of the delicate metal wire with the toner mixture and use a small spatula to adjust any excess color to ensure an even look; afterwards, use a lighter to heat the surface of the UV glue to remove any bubbles that may have formed; when working with colored sand, it is important to maintain the texture of the sand, resulting in a matte surface; to achieve this, the sand-to-glue ratio should be around 3:1; begin by pouring colored sand onto a palette and add glue in a small amount of times until the colored sand sticks without overflowing; it is important to add glue slowly to avoid any overflow; fill the artwork with the sand glue mixture and smooth it out to prevent the metal wire from overflowing; keep in mind that due to the unique characteristics of sand, additional drying and lighting time may be necessary;
step 5: making decoration:
place diamonds, mica, and abalone shells in wire outline, and cure with UV lamp for 2-5 minutes until the UV glue solidifies;
step 6: upper sealing:
to apply another layer of glue via a brush and remove any bubbles on the surface with a lighter; then, cure the craft for 5-10 minutes and let it stand for 1-2 hours until the surface is completely dry; make sure the interior is cooled, smooth and non-sticky before completing the front;
a. if there are any attachments, the delicate glue crafts are now finished;
b. if there is no attachment, continue to the next step;
step 7: PET tape removing:
to finish the craft, start by tearing off the transparent tape from the drawing; then remove the handicraft carefully; cure with the UV light on the back of the craft, which is covered by the PET tape; this will help to bake the glue; finally, remove the green PET tape;
step 8: reprocessing, bottom sealing and decoration:
to create a glittering effect, it is required to follow these steps; first, use powder 3 to smear the bottom surface of the craft; next, apply a layer of UV glue on the back and carefully check for any bubbles; then, use a lighter to cure it, and seal it with a light;
remove the excess glue around the wire frame with a nail file or scissors, taking care not to cut the wire;
to complete the craft, adorn the bottom and follow the instructions provided in steps six and seven once again;
this step may be skipped if not required;
step 9: attachments mounting:
to finish the production of filigree enamel crafts, it is necessary to install the appropriate accessories.

2. The filigree glue dripping enamel painting process of claim 1, wherein the attachments can be various items such as wooden boards, porcelain plates, mobile phone cases, refrigerator magnets, acrylic sheets, jewelry boxes, etc.

3. The filigree glue dripping enamel painting process of claim 1, wherein in the second step, insert and secure the No. 1 screw, and reserve a spot beforehand to make it easier to add necklaces, earrings, and keychains later on.

4. The filigree glue dripping enamel painting process of claim 1, wherein characteristics of No. 1 powder: bright, texture with glittering particles.

5. The filigree glue dripping enamel painting process of claim 1, wherein characteristics of No. 2 powder: luminous, glowing at night under sufficient light during the day.

6. The filigree glue dripping enamel painting process of claim 1, wherein characteristics of No. 3 powder: polarizing effect.

7. The filigree glue dripping enamel painting process of claim 1, wherein for the installation accessories of jewelry, necklaces, earring hooks, and ear studs could be used; additionally, applying UV glue to brooch buckles, ring holders, and duckbill clips; when applying UV glue to brooch buckles, it is important to dry them by cure with a light on them; this will complete the production process for the filigree UV jewelry.

8. The filigree glue dripping enamel painting process of claim 1, wherein when making an artwork, various types of glue such as UV glue, AB glue, crystal hard glue, transparent or opaque quick-drying glue, or sand-fixing glue could be selected depending on the situation.

9. The filigree glue dripping enamel painting process of claim 1, wherein, during processing, mica flakes, shell flakes, sequins, glitter powder, manicure diamonds, dried flowers, plastic decorations, or photos could be added.

10. The filigree glue dripping enamel painting process of claim 1, wherein the mixed glue can be colored with a variety of substances, such as colored sand, color powder, glitter powder, luminous powder and color essence.
